(19) United States
(12) Patent Application Publication
(10) Pub. No.: US 2007/0042252 A1
(43) Pub. Date: Feb. 22, 2007

(54) Solid state, thin film proton exchange membrane for fuel cells

(76) Inventor: Rudolf Feodor Kazarinov, Sedona, AZ (US)

Correspondence Address: Wendy W. Koba, PO Box 556, Springtown, PA, 18081, US

(21) Appl. No.: 11/204,600

(22) Filed: Aug. 16, 2005

(51) Int. Cl. H01M 8/02; H01M 8/10

(52) U.S. Cl. 429/34; 429/32; 429/38

(57) ABSTRACT

A fuel cell according to the invention comprises a multilayer proton exchange membrane having high proton conductivity in the temperature range of 300-500° C. This is achieved by the use of very thin (<1 μm) metal oxide polymer films on a metal substrate by electrolytic anodizing of a metal alloy. An exemplary proton exchange membrane according to the invention comprises a Ta₂₋ₓHfₓO₅ film fabricated on a niobium foil. The invention allows for a significant increase in power density and, therefore, a significant reduction in fuel cell cost per unit power.

### TECHNICAL FIELD

The present invention relates to fuel cells for vehicular power source applications and, more particularly, to thin film proton exchange membrane fuel cells.

### BACKGROUND OF THE INVENTION

Since the chemical energy per mass of hydrogen (124 MJ/kg) is at least three times larger than that of other chemical fuels (for example, the equivalent value for liquid hydrocarbons is 47 MJ/kg), it is considered as the number one candidate for future car fuel. However, the ability to safely and efficiently store hydrogen for vehicular power source application presents a formidable problem.

Classical high pressure tanks, even tanks made of novel carbon-fiber reinforced composite materials, are considered unsafe. Moreover, these high pressure containers, when full, would contain only approximately 4% hydrogen by mass (4 wt %), while at least 6-7 wt % hydrogen is required by the US Department of Energy (DOE) standards. Keeping hydrogen stored as in liquid form is also considered to be dangerous and impractical.

There is one safe way of hydrogen storage, based on the metal-to-metal phase transition of some metals (e.g., Pd, RE), or metal compounds (e.g., Ni₅La, Mg₂Ni), in which hydrogen is incorporated into metal hydrides such as Ni₅LaH₆ or Mg₂NiH₂. These phase transitions are reversible and exhibit a relatively small enthalpy. The most convenient Ni₅LaH₆→Ni₅La+H₂ phase transition that takes place at room temperature and standard atmospheric pressure. This particular chemistry is widely used for rechargeable batteries. However, all of these systems provide only about 2-3 wt % of hydrogen storage. The only known reversible process providing 7.6 wt % of hydrogen is the metal-to-semiconductor phase transition Mg+H₂→MgH₂, which requires a temperature of approximately 300° C. for transition at atmospheric pressure. Recent experiments with vanadium and nickel-doped Mg have demonstrated fast kinetics of hydrogen absorption and desorption, where it takes only a few minutes to load or unload a powder of this material with hydrogen. The problem here is not the temperature of the transition, but its enthalpy. In particular, it takes approximately 78 kJmol_{H}⁻¹ to melt MgH₂ into H₂ and Mg. This is an unacceptable loss of energy, since a conventional combustion engine efficiency is only about 20% and fuel cells have an efficiency of 40-50%. This problem could be resolved if the wasted energy (the remaining 80-60%) is utilized for the melting of magnesium hydride. However, neither the combustion engine or any other known fuel cells can operate at temperatures in the range of 300-350° C.

The basic idea behind fuel cells is to place an ion conductor (conducting only H⁺ or O⁻ ions) between the anode and cathode electrodes contacting to hydrogen and oxygen, respectively, thus forcing electrons to propagate through an external electrical circuit connected to the electrodes in order to accomplish the chemical reaction between hydrogen and oxygen to create water. In this process, the difference in chemical potential of a hydrogen atom in the H₂ molecule and a molecule of H₂O is converted into electrical potential appearing between the anode and cathode electrodes. Catalysts such as Pt or Ni are being deposited on electrodes in order to decompose hydrogen and oxygen molecules into atoms. The simplest examples of ion conductors are water-based alkaline and acid electrolytes. Phosphoric acid fuel cells, operating with highly-concentrated acid, can operate at temperatures up to 200° C.

Solid state electrolytes have also been developed. The polymer protonic conductor Nafion was developed for a proton-exchange membrane (PEM). Proton Exchange Membrane Fuel Cells (PEMFC) are believed to be the best type of fuel cell as the vehicular power source to eventually replace the gasoline and diesel internal combustion engines. First used in the 1960's for the NASA Gemini program, PEMFCs are currently being developed and demonstrated for systems ranging from 1 W to 2 kW. PEMFC fuel cells use a solid polymer membrane (a thin plastic film) as the electrolyte. This polymer is permeable to protons when it is saturated with water, but it does not conduct electrons. The fuel for the PEMFC is hydrogen, and the charge carrier is the hydrogen ion (proton). At the anode, the hydrogen molecule is split into hydrogen ions (protons) and electrons. The hydrogen ions permeate across the electrolyte to the cathode while the electrons flow through an external circuit and produce electric power. Oxygen, usually in the form of air, is supplied to the cathode and combines with the electrons and the hydrogen ions to produce water. In particular, the reactions are the electrodes are as follows:

Anode Reactions: 2H₂ [symbol] 4H⁺+4e⁻

Cathode Reactions: O₂+4H⁺+4e⁻ [symbol] 2H₂O

Overall Cell Reactions: 2H₂+O₂ [symbol] 2H₂O.

Compared to other types of fuel cells, PEMFCs generate more power for a given volume or weight of fuel cell. Other advantages result from the electrolyte being solid material, compared to a liquid. The sealing of the anode and cathode gases is simpler with a solid electrolyte, and therefore, less expensive to manufacture. The solid electrolyte is also more immune to difficulties with orientation and has less problems with corrosion, as compared to many of the other electrolytes thus leading to a longer cell and stack life.

One of the disadvantages of the Nafion PEMFC for some applications is that the operation temperature is relatively low (T<100° C.). At this temperature, the rate of cathode chemical reaction and current density is low, even if a significant amount of platinum as the cathode catalyst is used. As a result, the fuel cell cost per unit of power is very high. Moreover, since the electrolyte is required to be saturated with water to operate in an optimal manner, careful control of the moisture of the anode and cathode streams is required.

The other type of solid state fuel cell is the solid-oxide fuel cell (SOFC), which employs a yttrium-stabilized zirconium oxide ceramic as an electrolyte that conducts oxygen ions at temperatures of approximately 1000° C. This type of fuel cell can use coal in gaseous form as a fuel, with an efficiency of up to 80%, with particularly applicability to power plants. The problem with this type of fuel cell is that the by-products of the reaction dilute the fuel itself.

In order to accelerate the cathode and anode chemical reactions of PEMFCs, researchers have also been looking into metal oxide protonic conductors, since these conductors can operate at elevated temperatures. As the hydrogen ion is smaller, it is reasonable to believe that it may be more mobile, and spread more quickly than the oxygen ion. Studies have revealed that the protonic conduction properties of a certain number of oxides (based, notably, on rare-earth doped BaCeO₃, BaZrO₃ and Ba₃(CaNb₂)O₉). Conductivity levels of approximately 10⁻¹ S/cm have been measured at 600° C. in perovskites based on BaPrO₃.

### SUMMARY OF THE INVENTION

The present invention relates to an article that comprises a solid oxide fuel cell having features that can result in the reduction of the operation temperature and an increase in the power density of the fuel cell. In particular, the present invention is directed to a thin film solid state fuel cell that is compatible with MgH₂ hydrogen storage and is capable of operating in the temperature range of 300-400° C. In the proposed fuel cell, the thickness of the proton conductor is a fraction of a micron, allowing for a reduction of its resistance by a factor of a thousand which, in turn, allows significant increase of fuel cell power density and efficiency.

More specifically, the fuel cell of the present invention comprises a multilayer solid state structure on a metal substrate, and contacts that facilitate flowing a current through the multilayer structure. The multilayer structure comprises a metal oxide polymer protonic conductor and metal coatings on both the protonic conductor an the metal substrate. The metal substrate is made of a metal foil having high hydrogen permeability, such as niobium, vanadium or tantalum. The metal oxide polymer protonic conductor is made by electrolytic anodizing of a metal alloy film deposited on the metal substrate, for example, by co-sputtering of transitional metals having different valences. Hafnium and zirconium-doped tantalum are two such examples of such an alloy. A relatively small thickness of the protonic conductor layer (e.g., 0.1-0.5 μm) allows for a significant reduction of its resistance. This results in an increase of power density and efficiency at moderate operating temperatures. Another possibility for a metal oxide thin film protonic conduct is an ReOx film made by electrochemical deposition. The metallic coatings of the protonic conductor and the metal substrate comprise thin films of metals having a large electron work function, such as platinum, palladium or nickel. These films operate as catalysts enhancing decomposition of hydrogen and oxygen molecules into atoms. Encapsulation of the protonic conductor between the metal substrate and the metal coating also preserves high proton concentration in the conductor at elevated temperatures.

Other and further aspects of the present invention will become apparent during the course of the following discussion and by reference to the accompanying drawings.

### BRIEF DESCRIPTION OF THE DRAWINGS

Referring now to the drawings,

FIG. 1 illustrates an exemplary fuel cell formed in accordance with the present invention;

FIG. 2 is a graph showing the solubility of hydrogen in various metals, with a standard cc of hydrogen per 100 g of the metal; and

FIG. 3 is a graph showing the permeability of hydrogen in a selected subset of the metals associated with FIG. 2.

### DETAILED DESCRIPTION

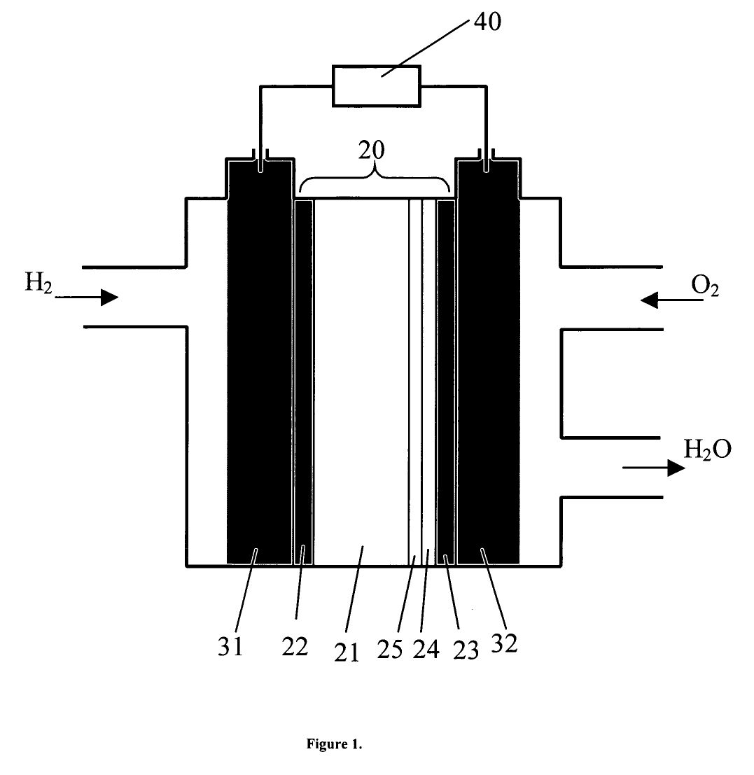

FIG. 1 illustrates, in schematic form, the relevant aspects of a fuel cell 10 formed in accordance with the present invention. Fuel cell 10 consists of a solid state multilayer structure 20 sandwiched between a pair of gas diffusion layers 31 and 32, where gas diffusion layers 31, 32 comprise porous carbide. In accordance with the present invention, multilayer structure 20 comprises a metal foil layer 21, with a metal oxide polymer (protonic conductor) 24 disposed over foil layer 21 and in contact with gas diffusion layer 31. Protonic conductor 24 functions as the solid electrolyte layer in the fuel cell structure. In accordance with the present invention, metal foil layer 21 comprises a metal with a relatively high hydrogen permeability, such as niobium, vanadium or tantalum and generally exhibits a thickness on the order of 25-250 μm. A first metallic coating layer 22 is formed over metal foil layer 21 so as to be disposed between first diffusion layer 31 and metal foil layer 22. A second metallic coating layer 23 is formed over protonic conductor 24 so as to be in contact with second diffusion layer 32. First and second metallic coating layers 22, 23 may comprise a metal such as platinum, palladium or nickel.

An external electrical circuit 40 is coupled between first and second diffusion layers 31, 32, where these layers function as the anode and cathode of fuel cell 10. In general, external electrical circuit 40 may be considered as a resistance disposed between the anode and cathode.

Hydrogen gas H₂ is supplied, as shown, to multilayer structure 20 through a first input port 42 and directed to first gas diffusion layer 31. Oxygen gas O₂ (generally, air) is supplied through a second input port 44 to multilayer structure 20 through second gas diffusion layer 32. An output port 46 is also formed, as shown, to allow for the exit of water resulting from the hydrogen-oxygen reaction.

Metal foil 21 provides the mechanical support for protonic conductor 24, while not impeding the propagation of hydrogen atoms from first gas diffusion layer 31 to solid electrolyte (protonic conductor) layer 24. Since protonic conductor layer 24 will conduct only H⁺ ions, the interface between protonic conductor 24 and metal foil 21 will divide the hydrogen ions (H⁺) and the electrons, thus forcing the electrons to propagate through external electrical circuit 40 to accomplish the chemical reaction between the hydrogen and oxygen and create water. In this process, the difference in chemical potential between hydrogen atoms in the H₂ molecule and a molecule of water is converted into an electrical potential appearing between the anode electrical contact (first diffusion layer 31) and the cathode electrical contact (second diffusion layer 32).

Hydrogen permeability of a metal depends on three factors: (1) the hydrogen solubility in the metal; (2) the hydrogen diffusion coefficient in the metal; and (3) the electron work function of the metal (which determines the ability of this metal to separate hydrogen molecules into hydrogen atoms at the metal's surface).

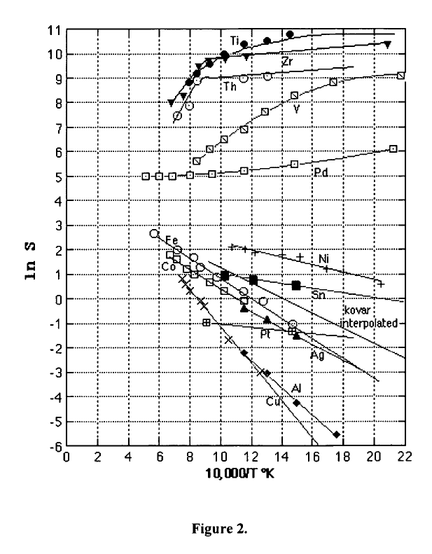

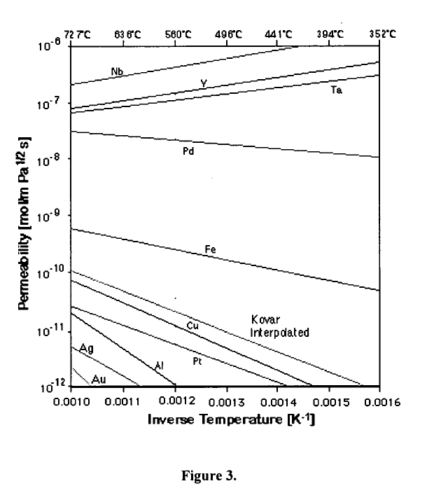

The solubility of hydrogen in different metals is illustrated in the graph of FIG. 2. It can be seen that the hydrogen solubility of transition metals have a valence number of four (i.e., titanium, zirconium) is greater than that of other metals. However, with particular reference to FIG. 3, transition metals having a valence of five are shown to be better candidates for metal foil layer 21 of fuel cell 10 of the present invention. In particular, the high value of hydrogen permeability of these metals results from their low activation energy for hydrogen diffusion. In particular, the diffusion coefficient D_{H} can be expressed as follows:
D_{H}=D₀exp(−E_{A}/kT),
where E_{A} is defined as the diffusion activation energy, k is Boltzman's constant, T is defined as the absolute temperature and D₀ is defined as approximately av, where “a” is the metal lattice constant and “v” is the hydrogen thermal velocity: v=(3kT/M)^{1/2} (M being the mass of a proton).

For vanadium, D₀ is approximately 0.01 cm²/sec at T=600° K. and E_{A}=50 meV, resulting in D_{H} of approximately 0.003 cm²/sec (see, for example, S. Hayashi et al, “Hydrogen Absorption and Diffusion in Vanadium-Based Alloys” Proc. Int. Symp. Mat. Chem. Nucl. Environment, pp. 505-513, 1996). Having this value of hydrogen diffusion coefficient and a hydrogen concentration (C) of approximately 10% (hydrogen-to-vanadium atomic ratio H/V of approximately 0.1), a vanadium foil of thickness 250 μm does not present any limitation to the fuel cell current density and efficiency.

Metals such as vanadium, niobium or tantalum dissolve hydrogen atoms, but do not dissolve hydrogen molecules. As was first shown by M. A. Pick et al. (see Physical Review Letters, Vol. 43, p. 286 1979), coating of these metals with a thin film of metals having an electron work function exceeding 5 eV (e.g., Pt, Pd, Ni) dramatically enhances the decomposition rate of hydrogen molecules into atoms at the metal surface. Similarly, these materials enhance the decomposition of oxygen molecules, thus accelerating the hydrogen-oxygen reaction to form water. Diffusion layers 31, 32 of fuel cell 10 of FIG. 1 are used to implement these functions.

Inorganic protonic conductors are oxides of metals with large atomic numbers. Perovskites and some binary metal oxides, such as Nd₂O₃, exhibit high proton mobility. Proton solubility of these materials relies on their doping with electron acceptors that provide absorption of water. For perovskites, acceptors are defined as elements of valence three (Sc, Y, Ga or a rare earth) substituting Zr, Ti or Ce. These acceptors from the oxygen under-saturated chemical bond defects that pick up OH⁻ ions from H₂O, leaving H⁺ ions chemically unbound. Positively charged protons are attached to oxygen atoms of the basic material by the polarization force.

Yttrium-doped BaZrO₃ is an example of protonic conductor which has large proton mobility and concentration. Proton conductivity of BaZr_{0.75}Y_{0.25}O₃ at a temperature of approximately 400° C. is approximately 0.3 S/cm. Sintered at a temperature of approximately 1700° C., this material is a large grain poly-crystal. This so-called “bulk” material has much higher proton mobility than a ceramic made of a mixture of small micro-crystals. A 1 μm thick film of bulk BaZr_{0.75}Y_{0.25}O₃ would have a resistance of approximately 0.003Ωcm² at a temperature of 400° C.

Relatively thin (for example, 6 μm) BaZr_{0.80}Y_{0.20}O₃ films have been made by laser beam evaporation. However, these films have low proton conductivity at temperatures in the range of 300-400° C. because of their small grain structure. Proton conductivity of this material is limited by the grain boundary contribution.

A way of fabricating of a uniform, thin and continuous metal oxide layer is anodizing of metals. This method is utilized in the electrolytic capacitor industry. In particular, Ta₂O₅ is made by anodizing Ta, and results in an excellent dielectric material. It is believed that this material is not a crystal, but an amorphous material or a metal oxide polymer (glass). It has been found that at temperatures in the range of 300-400° C. this material has very low electron conductivity (G˜10⁻⁶ 1/{fourth root}cm² for 0.5 μm thick Ta₂O₅ layer, and the activation energy for electron conductivity E_{act}=0.55 eV.)

Hafnium and zirconium are acceptors in Ta₂O₅ . Hafnium (or zirconium) doped Ta₂O₅ (Ta₂₋ₓHfₓO₅, operating as protonic conductor 24 of FIG. 1, can be made by anodizing of a hafnium- or zirconium-doped tantalum film sputtered on metal foil 21 of fuel cell 10. The molar concentration of protons in Ta₂₋ₓHfₓO₅ saturated by water is approximately x. It has been established experimentally that the proton conductivity of metal oxides is correlated with the volume of their unit cells (or volume occupied by a molecule). That is, the higher the volume, the higher the conductivity. The volume of an BaZrO₃ unit cell is 85 cubic Angstroms while that of Ta₂O₅ is 107 cubic Angstroms. Therefore, the proton conductivity of Ta₂₋ₓHfₓO₅ is expected to be higher than that of BaZr₁₋ₓYₓO₃.

The advantage of the proposed invention is that the protonic conductor is much thinner than that of conventional ceramic designs and does not exhibit grains. This allows a low resistance of the proton exchange membrane to be achieved at a relatively low operation temperature. For example, replacing a millimeter thick ceramic by a micron thick metal oxide polymer allows operation at 400° C. instead of 600° C. with resistance reduction by a factor greater than 100. Reduction of protonic conductor resistance results in an increase of power density and efficiency of the fuel cell. Also, encapsulation of the protonic conductor between metal foil 21 and a metal film 23 prevents oxygen depletion (water evaporation) of oxides and preserves a high level of H⁺ ion concentration at high operation temperatures. Proton concentration in the encapsulated metal oxide protonic conductor does not depend on temperature and water pressure of the ambient.

The electrical power generated in external electrical circuit 40 of fuel cell 10 results mainly from proton diffusion against a potential built between protonic conductor 24 and metal films 23, 25. In equilibrium, this potential compensates for the difference between proton chemical potentials in protonic conductor 24 and metal films 23, 25, making the electrochemical potential equal across the various layers within the structure. While a proton chemical potential of a protonic conductor is fixed (for a given temperature), the proton chemical potential of a metal depends on the hydrogen processure and the metal electron work function. In particular, the higher the chemical potential difference between metal films 23 and 25, the higher the voltage of the fuel cell.

What is claimed is:

1. A solid state multilayer proton exchange membrane for fuel cells comprising a metal foil plate having a high hydrogen permeability;
a voltage enhancement layer adjacent to said metal foil plate wherein said voltage enhancement layer comprises a sub-micron thickness metal film having a large value of electron work function;
a metal oxide polymer layer adjacent to said voltage enhancement layer, wherein said metal oxide polymer layer comprises at least two metals having different valences, a first metal coating adjacent to said metal oxide polymer layer; and
a second metal coating adjacent to said metal foil plate.

2. The solid state multilayer proton exchange membrane as defined in claim 1 wherein the metal oxide polymer layer comprises an anodized metal alloy film having at least two metals of difference valences.

3. The solid state multilayer proton exchange membrane as defined in claim 2 wherein said metal alloy film is a hafnium-doped tantalum film.

4. The solid state multilayer proton exchange membrane as defined in claim 1 wherein the first and second metal coatings are metal films having a large value of electron work function.

5. The solid state multilayer proton exchange membrane as defined in claim 4 wherein the first and second metal films are selected from the group consisting of: nickel, palladium and platinum.

6. A solid state multilayer proton exchange membrane for fuel cells comprising
a metal foil plate having a high hydrogen permeability;
a voltage enhancement layer adjacent to said metal foil plate and comprising a sub-micron thick metal film having a large value of electron work function;
a metal oxide polymer layer adjacent to said voltage enhancement layer, wherein said metal alloy film comprises at least two Rhenium oxide components having different valences,
a first metal coating adjacent to said metal oxide polymer layer; and
a second metal coating adjacent to said metal foil plate.

7. The solid state multilayer proton exchange membrane of claim 6 wherein the metal oxide polymer layer is fabricated by electrolytic deposition on said voltage enhancement layer using an electrolyte.

8. The solid state multilayer proton exchange membrane as defined in claim 6 wherein said first and second metal coatings are metal films having a large value of electron work function.

9. The solid state multilayer proton exchange membrane as defined in claim 8 wherein said metal films are selected from the group consisting of: nickel, palladium and platinum films.

10. A solid state, proton exchange fuel cell comprising a solid state multilayer proton exchange membrane comprising a metal foil plate having a high hydrogen permeability, a voltage enhancement layer adjacent to said metal foil plate wherein said voltage enhancement layer comprises a sub-micron thickness metal film having a large value of electron work function, and a metal oxide polymer layer fabricated by electrolytic anodizing of a metal alloy film, said metal oxide polymer layer deposited on one surface of said metal foil layer, wherein said metal alloy film comprises at least two metals having different valences; a first metal coating adjacent to said metal oxide polymer layer, and a second metal coating adjacent to said metal foil layer;
an oxygen gas transmitting structure adjacent to said first metal coating of said solid state multilayer proton exchange membrane and electrically contacted to said first metal coating; and
a hydrogen gas transmitting structure adjacent to said second metal coating of said multilayer proton exchange membrane and electrically contacted to said second metal coating.

11. A solid state, proton exchange fuel cell as in claim 11 wherein the first and second gas transmitting structures comprise porous carbon plates.
